(19) United States
(12) Patent Application Publication
(10) Pub. No.: US 2012/0173129 A1
(43) Pub. Date: Jul. 5, 2012

(54) Method for operating a starter controller, computer program product, and starter controller

(76) Inventors: Hartmut Wanner, Herrenberg-Oberjesingen (DE); Stefan Erlenmaier, Sersheim (DE); Ingo Richter, Markgroeningen (DE); Uwe Daurer, Kornwestheim (DE); Philip Zernial, Stuttgart (DE); Karl-Otto Schmidt, Keltern (DE); Henning Stoecklein, Eberdingen (DE)

(21) Appl. No.: 13/381,730

(22) PCT Filed: May 4, 2010
(86) PCT No.: PCT/EP10/56025

§ 371 Date: Mar. 20, 2012

(30) Foreign Application Priority Data
Jul. 1, 2009 (DE) 102009027407.3

(51) Int. Cl. F02N 11/08

(52) U.S. Cl. 701/113; 123/179.3

(57) ABSTRACT

In a method for operating a starter device having a starter motor for starting an internal combustion engine, the starter motor is switched on and off via a starter controller having a switching relay when the starter motor is acted on by electrical power from an electrical energy store. The starter motor is controlled by the starter controller in a power-regulated manner during the starting operation.

### BACKGROUND OF THE INVENTION

1. Field of the Invention

The present invention relates to a method and a computer program for operating a starter device having a starter motor for starting an internal combustion engine, it being possible for the starter motor to be switched on and off via a starter controller having a switching relay when the starter motor is acted on by electrical power from an electrical energy store. The present invention also relates to a starter device for an internal combustion engine of a vehicle, having a starter motor, an electrical energy store, and a switching relay which is controllable by a starter controller and which forms an electrical switching contact between the starter motor and the electrical energy store.

2. Description of Related Art

It is known to directly connect via a feed line a starter device, having a starter motor for starting an internal combustion engine, to a positive terminal of an electrical energy store, in particular a starter battery, and to connect a return line to the negative terminal—for motor vehicles, typically via the body. The cabling is relatively cost-effective in manufacturing and costs, essentially due to its having a single line on the positive terminal side. The starter device is controlled by a mechanical or an electromechanical controller which may be linked to a control electronics. A design of a starter device of this type is simple. The starter device is operated in a vehicle for starting an internal combustion engine in a temperature range which is sometimes wide due to seasonal temperature fluctuations. Also, for operation using a start-stop system, the operating temperature range is greater than for a start merely with a cold internal combustion engine.

Published German patent application document DE 102 31 088 A1 describes an actuator for switching on a starter motor, having two parallel-connected transistors as an actuator, in principle only one transistor operating, and means for testing the functionality of each transistor being provided.

An object of the present invention is to refine a method for operating a starter device, a computer program product, and a starter device of the type mentioned at the outset in such a way that that the starter device for starting an internal combustion engine has a higher service life, even in the case of fairly intensive use.

### BRIEF SUMMARY OF THE INVENTION

An idea of the present invention is to examine the requirement profile of a starter motor, and on the basis thereof to act on the starter motor with electrical power in a power-oriented manner. It has been determined that the requirement profile of the starter motor, i.e., the power required by the starter motor, is a function of the necessary cranking power of the internal combustion engine. The cranking torque of the internal combustion engine varies as a function of the temperature of the engine, primarily due to the viscosity of the motor oil present therein. At a standard temperature around +20° C., for example, the cranking torque is less than for a cold start of the internal combustion engine. As a result of the identified requirement profile, the required electrical torque power of the starter motor should be greater at low temperatures, and low at higher temperatures. In addition, the electrical power of an electrical battery is reduced at low temperatures.

The object is achieved in that during the starting operation the starter motor is controlled by the starter controller in a power-regulated manner. It is thus possible to vary the maximum available power of the starter motor, and to reduce wear on a starter pinion, on the annular gear of the internal combustion engine, on abrasive carbon brushes on the commutator, on the bearings, and on the contact pieces at the switching relay. In addition, a greater number of operations by the starter motor and the starter device may be achieved overall, which is advantageous in particular for the use of start-stop systems.

In addition, by suitably selecting the power distribution, the voltage drop in the vehicle electrical system may be influenced in such a way that the voltage does not fall below a minimum voltage for electronic components to be supplied. Aids used for voltage stabilization, such as so-called DC/DC converters, for example, may thus be dispensed with.

According to one method, which refines the present invention, the starter motor is controlled in discrete power stages in a power-regulated manner. It would be possible to variably control the starter motor, adapted as a direct function of the variably changed engine cranking torque. However, such variable control is complicated. According to one simple method, discrete power stages are therefore provided. Control may thus be implemented in a simpler and more cost-effective way.

To detect a main influencing variable which determines the engine cranking torque of the internal combustion engine, the starter controller queries information concerning the temperature of the internal combustion engine, and the starter motor is controlled by the internal combustion engine in a power-regulated manner as a function of a specified, detected instantaneous temperature range.

According to one simplified method, the starter motor is controlled by the starter controller in three, preferably four, stages in a power-controlled manner. Three or four stages are advantageously sufficient to subdivide the required power, i.e., the required power profile, of the starter motor into a minimum required power, an increased power, a greatly increased power, and a maximum power. As a result of this subdivision, the wear on components involved in the starting operation may be reduced, and the required electrical power resources may be economically and carefully used.

The power stages are preferably switched during the starting operation by the controller or starter controller as a function of time. Thus, the starter motor is able to mesh at a low power level and drive the internal combustion engine for starting at a stepped power level, it being possible for the starter controller to increase this power in a time-controlled manner after a short starting time. The time-dependent connection may or may not be a function of the temperature of the internal combustion engine. The time-dependent control may also be adapted in a typical specific manner, and be coupled to a self-learning function of the starter controller which takes into account and detects the aging changes of the starter device during the starting operation.

The object is also achieved by a computer program product in that the computer program product is loadable with program instructions in a program memory in order to carry out all the steps of a method described above when the computer program product is executed in the starter controller. The computer program product has the advantage that it may be adapted, with the aid of parameters, in a typical specific manner for a starter device for starting an internal combustion engine, so that a very simple and cost-effective adaptation is possible. Measured values from existing sensors, for example one or multiple temperature sensors, or existing time switches, or for processor approaches using counters, may be taken into account in order to control the starter motor, with the aid of the starter controller, as a function of various parameters and in a power-regulated manner.

The object is also achieved by a starter device in that the starter device is provided with a power regulation device for the starter motor. The power regulation device has the advantage that the electrical power of a battery is adapted to the cranking resistance of the internal combustion engine, and thus the wear on components involved in the starting operation is reduced overall, and electrical power is used economically. The service life of the starter device is thus increased, in particular also for an increased number of operations or cycles due to a start-stop operation of the vehicle.

According to one preferred specific embodiment, in order to design the power regulation device in the simplest manner possible, the power regulation device has switchable feed lines having defined resistances which may be switched on and off via the starter controller with the aid of circuit breakers, in particular having switching relays. It is a concept of the present invention to provide switchable feed lines with a resistor, for example a series resistor, in order to adapt the available power. For switching the feed lines on and off, heavy-duty circuit-breakers, for example electronic switches, may be used; electromechanical switching relays are preferably used, since with the aid of these relays high currents are easily switchable with a long service life.

The resistor may be integrated into a subsection of the feed line. Alternatively, the resistor may extend over the entire feed line as an increased internal power resistor.

According to another preferred specific embodiment, the switchable feed lines are made of a material having a higher resistance than copper. The switchable feed lines are preferably made of steel and/or aluminum.

Steel and aluminum have a higher resistance than copper, and are also less expensive materials than copper. Steel is less expensive than aluminum, and also has a higher resistance. Thus, both materials are inexpensive overall.

According to one preferred specific embodiment, the switchable feed lines are switched on the positive terminal side, between the starter motor and the energy store, in particular the battery. Thus, the return line may have an efficiently short design over the vehicle body, the same as for conventional starter devices.

The switchable feed lines are switched as series resistors. Closing multiple feed lines increases the available electrical power compared to a single forward line, since the magnitude of the ohmic resistance in the effective feed line is reduced overall by switching resistors in parallel.

Alternatively, the power regulation device may be switched between the starter motor and the energy store on the negative terminal side. By using multiple switchable lines which are made of a material which has a higher resistance and is less expensive than copper, the power for operating a starter motor may be varied. The ground-side attachment is preferably easier to implement, since these lines normally also have a simpler design; i.e., these are actually complete lines from the starter to the body or to the battery without interruptions. In the positive-side configurations, a plurality of additional interruptions such as fuses, switches, immobilizers, and similar components are present which complicate installation of multiple parallel feed lines. In addition, semiconductor switching elements as so-called low side switches in the ground branch circuit may be controlled in a somewhat simpler manner than high side switches in the positive branch. In principle, however, there is no difference.

It is understood that the features mentioned above and to be explained below may be used not only in the particular stated combination, but also in other combinations.

### BRIEF DESCRIPTION OF THE DRAWINGS

FIG. 1 shows a schematic circuit diagram of a starter device according to a first specific embodiment.

FIG. 2 shows a circuit diagram of a starter device according to a second specific embodiment.

FIG. 3 shows a circuit diagram of a starter device according to a third specific embodiment.

FIG. 4 shows a schematic circuit diagram of a starter device according to a fourth specific embodiment.

FIG. 5 shows a table of operating states of the starter device.

FIG. 6 shows a flow chart of a sequence of the method according to the present invention.

### DETAILED DESCRIPTION OF THE INVENTION

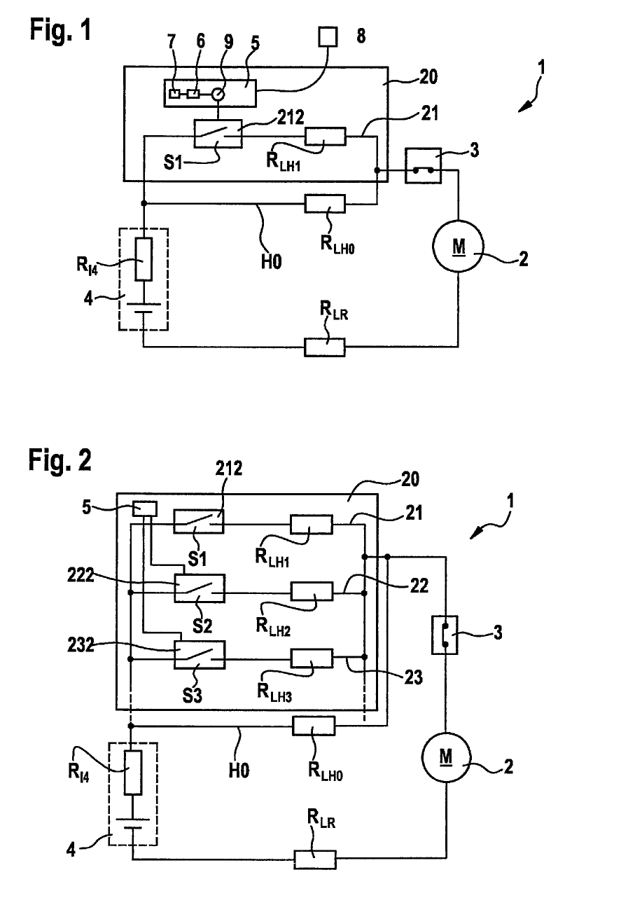

FIG. 1 shows a starter device 1 having a starter motor 2, and a switching relay 3 which is switched on the positive terminal side between a battery 4 and starter motor 2 via a forward line H0 (for the starter, this relay is referred to as an engagement relay, which takes over the mechanical engagement function of the pinion as well as the switching function for the main current, as explained in greater detail below). A starter relay at starter motor 2 which is used for meshing of a starter pinion, not illustrated, includes switching relay 3. Switching relay 3 is known from the related art. Forward line H0 has an ohmic resistor R_{LH0} and negative terminal-side return line R from starter motor 2 to battery 4 has an ohmic line resistor, denoted by R_{LR} for simplification. Battery 4 has an internal ohmic resistor R_{I4}. According to a first particular specific embodiment, starter device 1 is provided with a power regulation device 20 on the positive terminal side. Power regulation device 20 has at least one switchable feed line 21 which is parallel to forward line H0. Parallel switchable feed line 21 has a defined line resistor R_{LH1}. Resistor R_{LH1} of parallel feed line 21 is preferably not spatially limited to a single resistance, but, rather, as the result of a suitable material selection, extends over entire parallel feed line 21. Switchable feed line 21 having a higher resistance is preferably made of a material, for example steel or aluminum, which is less expensive than conventional forward line H0, which is made of copper. Aluminum has a conductivity of 37 m/Ω*mm², and steel has a conductivity of 10 m/Ω*mm², in contrast to the conductivity of copper, which is 57 m/Ω*mm². Parallel switchable feed line 21 may be switched on and off with the aid of a circuit breaker 212.

Circuit breaker 212 is either an electronic circuit breaker, for example a MOSFET, or an electromechanical switching relay. Circuit breaker 212 is controlled by a controller 5 having a CPU 6. Controller 5 is provided with a program memory 7, and is in information contact with a thermal sensor 8 for detecting the temperature of an internal combustion engine, which is not shown. CPU 6 is also connected to an electronic clock 9. Controller 5 together with CPU 6 and clock 9 thus forms a time switch.

After a switching contact S1 is closed by circuit breaker 212, the available electrical power of starter motor 2 is increased via feed line 21. The electrical power of starter motor 2 may thus be varied with the aid of power regulation device 20. Starter motor 2 may deliver a higher torque when increased engine cranking power is necessary for starting the internal combustion engine. The engine cranking power is higher at a low temperature, for example, due to the viscosity of the motor oil.

FIG. 2 shows a starter device 1 according to FIG. 1, with the difference that power regulation device 20 does not only include one parallel switchable feed line 21, but at least three parallel feed lines 21, 22, 23 are provided. Each of parallel feed lines 21, 22, 23 includes a switchable circuit breaker 212, 222, 232, respectively, which closes switching contacts S1, S2, S3, respectively, when this is specified by controller 5. Due to three parallel feed lines 21, 22, 23, it is possible to control starter motor 2 in a fairly large differentiated range in a power-regulated manner compared to the specific embodiment according to FIG. 1. Thus, a power surplus is avoided when the internal combustion engine is meshed and started. Unnecessarily high wear on the starter pinion, annular gear, bearings, and terminals of contact pins in the starter relay is prevented as the result of regulated power.

According to another particularly preferred specific embodiment, feed lines 21, 22, 23 are provided with different ohmic resistances, so that as the result of a specified selection of the forward connection of parallel feed lines 21, 22, 23 a defined power regulation 20 is carried out by controller 5 in order to control starter motor 2 in a defined manner.

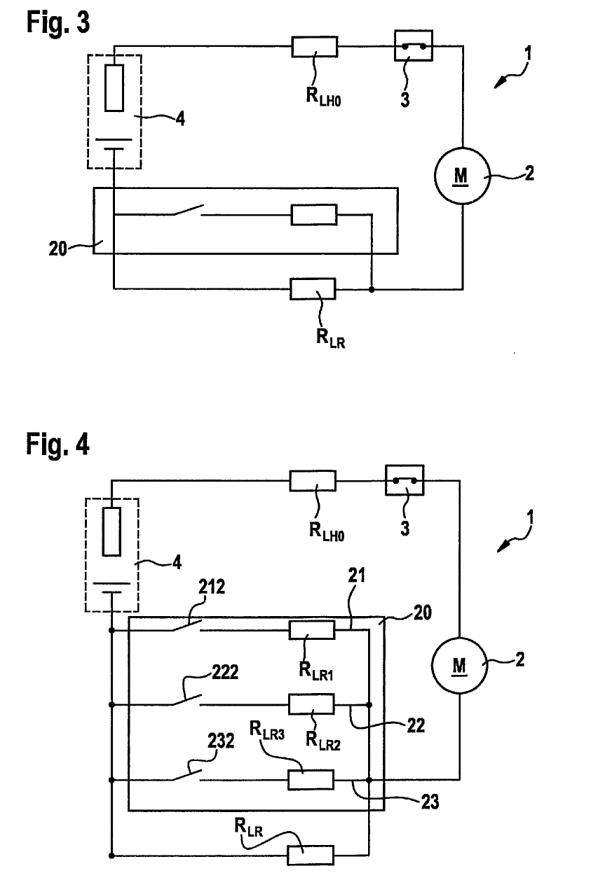

FIGS. 3 and 4 show an alternative specific embodiment to FIGS. 1 and 2, respectively, with the difference that at least one parallel feed line 21 is situated on negative terminal-side return line R between starter motor 2 and battery 4.

The resistance of feed lines 21, 22, 23 as return lines, which preferably extends over the entire line as described above, is denoted and illustrated in FIG. 4 by R_{LR1}, R_{LR2}, and R_{LR3} for simplification.

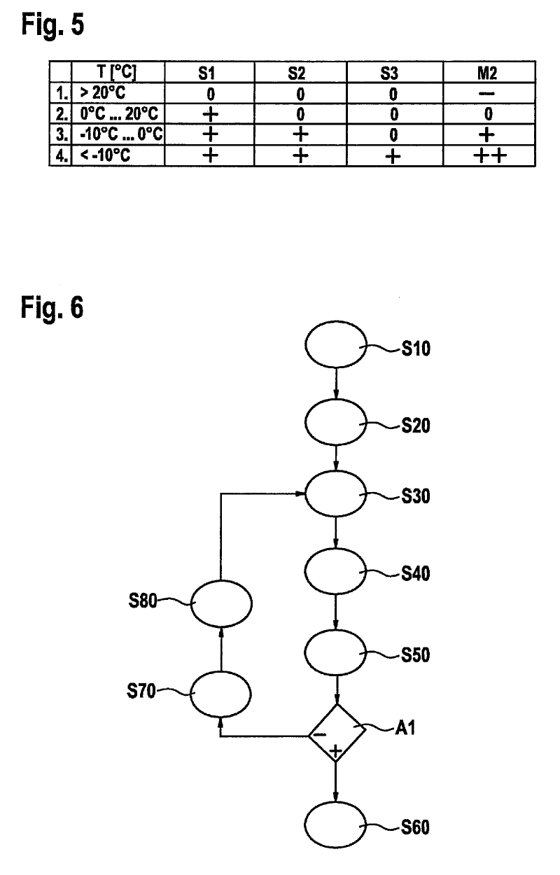

FIG. 5 shows a simplified diagram in the form of a table having four temperature ranges 1, 2, 3, 4 in which the internal combustion engine is started by starter device 1 in each case. In first temperature range 1, which is greater than +20° C., all switching contacts S1, S2, S3 are kept open by circuit breakers 212, 222, 232. Starter motor 2 is controlled via conventional feed line H0 via a switching relay 3.

In a second temperature range 2 between 0° C. and +20° C., controller 5 closes a defined circuit breaker, for example 212, 222, or 232. The overall resistance of the circuit, i.e., a power network, in starter device 1 is thus reduced, and the electrical starting power is increased. Starter motor 2 thus overcomes an increased engine cranking torque at the internal combustion engine.

According to a third temperature range 3 which is set between −10° C. and 0° C., for example, switching contacts S1 and S2 are closed. Switching contact S3 has not been closed by circuit breaker 232. In this temperature range 3, starter motor 2 has greatly increased power for an optimal start of the internal combustion engine.

In a fourth temperature range 4 the temperature is less than −10° C. In this temperature range, circuit breakers 212, 222, 232 via their switching contacts S1, S2, and S3, respectively, are closed, so that maximum power is delivered by battery 4, and the resistance in the overall circuit of starter device 1 is at a minimum, so that maximum electrical power is available at starter motor 2 in order to start the internal combustion engine with an increased engine cranking torque.

FIG. 6 shows a flow chart having a sequence of method steps which are executed by starter controller 5 in order to carry out the method according to the present invention.

In a first step S10 a start pulse, resulting, for example, from activating a starter button or from turning the ignition key, is detected by controller 5 via an information system, for example via a CAN bus. For a start-stop system, the start pulse may be detected as the result of releasing a foot brake or depressing a gas pedal.

Temperature sensor 8 is queried for the instantaneous temperature of the internal combustion engine in a second step S20.

The temperature is subsequently evaluated and assigned to a specific temperature range 1, 2, 3, or 4 in a third step S30.

In a step S40, it is determined which circuit breaker(s) 212, 222, and/or 232 is/are closed, and which remain(s) open, in power regulation device 20.

The main current path, i.e., forward line H0, is closed by switching relay 3 in step S50, thus energizing starter motor 2 and starting the internal combustion engine.

A query is then made in a query step A1 as to whether the internal combustion engine has been started within a specified time period t. If this is the case, switching relay 3 is switched off in step S60, and starter controller 5 reaches the end of the method sequence.

If the internal combustion engine has not yet been started after a specified time period, the electrical power is increased in a step 70 by connecting an additional feed line 21, 22, or 23 via a circuit breaker, thus improving the starting behavior of the internal combustion engine.

In a step S80, the new switching combination of starter controller 5 with the actually measured parameters is stored as a self-learning function in program memory 7.

Alternatively, individual switches 212, 222, and 232 may be slowly connected during a starting operation so that starter motor 2 does not load the vehicle electrical system with a sudden, very high starting current. The starter current is thus increased in a stepped manner during starting. All figures show only schematic illustrations which are not to scale. In addition, reference is made in particular to the illustrated figures as being essential to the present invention.

1-10. (canceled)

11. A method for operating a starter device having a starter motor for starting an internal combustion engine, comprising:
selectively switching, using a starter controller having a switching relay, the starter motor on and off when the starter motor is acted on by electrical power from an electrical energy store;
controlling, using the starter controller, the starter motor during the starting operation, in discrete power stages having corresponding defined resistances, in a power-regulated manner as a function of at least one of an assigned temperature range and time.

12. The method as recited in claim 11, wherein the starter controller (i) queries information concerning the temperature of the internal combustion engine prior to the starting operation with the aid of the starter motor, and (ii) controls the starter motor in a power-regulated manner as a function of the temperature of the internal combustion engine.

13. The method as recited in claim 11, wherein the starter motor is controlled by the starter controller in at least three stages in a power-regulated manner.

14. A non-transitory computer-readable data storage medium storing a computer program having program codes which, when executed on a computer, perform a method for operating a starter device having a starter motor for starting an internal combustion engine, the method comprising:
selectively switching, using a starter controller having a switching relay, the starter motor on and off when the starter motor is acted on by electrical power from an electrical energy store;
controlling, using the starter controller, the starter motor during the starting operation, in discrete power stages having corresponding defined resistances, in a power-regulated manner as a function of at least one of an assigned temperature range and as a function of time.

15. A starter device for an internal combustion engine of a vehicle, comprising:
a starter motor;
an electrical energy store;
a switching relay controlled by a starter controller, wherein the switching relay forms an electrical switching contact between the starter motor and the electrical energy store; and
a power regulation device having switchable, discrete power stages having corresponding defined resistances for the starter motor, the power stages being switchable as a function of at least one of an assigned temperature range and time.

16. The starter device as recited in claim 15, wherein the power regulation device has parallel switchable feed lines having defined ohmic resistors which are selectively switched on and off via the starter controller with the aid of switching relays.

17. The starter device as recited in claim 16, wherein the parallel switchable feed lines are made of at least one of steel and aluminum.

18. The starter device as recited in claim 16, wherein the parallel switchable feed lines are switched between the starter motor and the energy store.
